(19) United States
(12) Patent Application Publication
(10) Pub. No.: US 2007/0136173 A1
(43) Pub. Date: Jun. 14, 2007

(54) System for co-operative investing including co-operative option and futures exchange for structured financial products with revenue sharing

(76) Inventor: Franciscus Jacobus de Hoog, Steenwyjk (NL)

Correspondence Address: SANFORD J. PILTCH, ESQ., 1132 HAMILTON STREET, SUITE 201, ALLENTOWN, PA, 18101, US

(21) Appl. No.: 11/605,071

(22) Filed: Nov. 28, 2006

Related U.S. Application Data
(60) Provisional application No. 60/740,197, filed on Nov. 28, 2005.

(51) Int. Cl. G06Q 40/00

(52) U.S. Cl. 705/36 R

(57) ABSTRACT

A system for co-operative trading of options and futures through an automated Internet portal for structured financial products such as a butterfly spread option call or put, and utilizing a co-operative option and future exchange of investor member units for revenue or profit sharing among investors of pre-selected structured financial products.

### BACKGROUND OF THE INVENTION

1. Scope of the Invention

The invention relates to investment products and more particularly to a method, system and computer program to cooperatively invest in structured financial products, so-called CO Options, as well as a Cooperative Option & Futures Exchange for these structured financial products, to achieve netting advantages from investing cooperatively, and for revenue sharing or profit distribution between investors.

2. Description of the Related Art

There are many known methods or systems for mutually investing in plain vanilla investment instruments. There are many known structured investment instruments that make use of structured derivatives. However, there is no known system which allows individual investors the means to decide individually the extent of their exposure, while at the same time achieving the efficiency and cost advantages of cooperatively investing and making use of the possibility for revenue sharing or distributing profits between other investors.

Furthermore, there are currently no known exchange regulated investment products that allow private individual investors, with limited knowledge of options, to invest in complex option combinations by investing in structured financial products containing all the following characteristics. In this investment method, participation is based on the amount of money that is pledged by an investor at his/her discretion rather than the number of contracts, shares or certificates. Also, simple participation can be activated by a few mouse clicks via an Internet connection. There is low-cost participation and low minimum amount needed for participation. The product uses a simple and cost-effective structure when purchased on an individual basis compared to the underlying option combination that is complex and cost-ineffective when purchased on an individual basis. Additionally, the method yields a return when the underlying value is range-bound during the lifetime of the product. The investors' maximum loss is limited to their invested amount; subsequently there are no margin requirements for this investment product. The participants can opt for revenue sharing with other investors in order to improve the risk/return ratio. Lastly, it is not necessary to follow the day-to-day positions as it can be arranged that investors be prohibited from closing their positions once they have invested.

Normally, investors can determine their own exposure when they choose to invest in a complex option combination that yields a return when the underlying value remains within a price-range, for instance as with the so-called “butterfly-spread” familiar to option traders. However, in order to do so, they need to have sufficient money and knowledge of options and conditions specific to the options market and submit their different orders to the exchange through a broker.

If investors do this on an individual basis, their costs are high as they include: broker fees, exchange fees if charged separately and the bid-ask spread in the market. These costs are, in general, relatively higher for small orders than for large orders. In terms of a percentage, costs can sometimes amount to up to 50% of the invested amount. Furthermore, exchanges and brokers often charge a margin for such positions and upon closing of the position the investor again incurs some or all of the costs associated with the opening trade. The result of this being that it is expensive and difficult for small investors to trade on their range-bound vision.

Additionally, there is no way that they will be compensated for losses on their investment for choosing the wrong price-range due to a redistribution of profit achieved by other investors. The new structure will accommodate this specific type of redistribution because the different products issued by this system, method or computer programs, the so-called CO Options products are mutually excluding, i.e. they each generate revenue from different market circumstances at the expiration of the option position. The essence of the innovation here is that investors do not need to pay any upfront premium to protect the investment. In this new method they pay their investment protection premium afterward, and only when their investment is profitable. Their protection premium is taken from their profit. Also, investment protection for those investors who suffer losses is possible to the extent that a sufficient number of other investors are successful.

Summarizing, there is no known system that provides individual investors with the means to decide individually the extent of their exposure, while simultaneously offering them the possibility to achieve the efficiency and cost effectiveness of cooperatively investing as well as the possibility to share revenue with other investors.

The new process of investing by a method, system and computer program that allows for efficiency and cost advantages as well as the possibility for revenue sharing or profit redistribution between investors is needed. The present invention provides such a method, system and computer program for the buying process of the investments as well as a mechanism or system for revenue sharing and profit redistribution between individual investors.

This method, system or computer program can be operated as an Investors Cooperative or Company issuing new structured products to their members or investors. For a range-bound example of a cooperative alternative for the butterfly spread, to invest in a price-range, the so-called CO Options are issued. The method or system can also be operated as a Cooperative Option & Futures Exchange in which the exchange facilitates investors to invest in the CO Options.

In the following descriptions of the method, system and computer program, the CO Option is used as an example of an investment product created by this method or system. The following two variants of the CO Option are described: the CO Single, replicating a normal butterfly as currently known to option traders, and a similar product with the additional element of revenue-sharing, here called the CO Plus. It is to be understood that these examples are for illustrative purposes only and are not limiting.

Furthermore, a web server is required on which participants can log in securely and where they have access to their individual accounts. For the participants, the website should be easy to navigate and to use. It should give them the possibility to open and close an account, to enter orders into the system, to withdraw funds and to view their statements. Additionally, it should provide participants as well as prospective participants/members with information about the nature of the associated products as well as access to real-life examples.

An important element in the CO Plus product is the transformation of the financial products that are collectively bought on the exchange into different financial products that collectively still exhibit the same revenue characteristics but not individually as compared to the CO Singles. What is needed here is the possibility to evaluate how this transformation affects the risk/return trade-off for investors. Additionally, this invention contains a formula to calculate the theoretical value of a position in the revenue-sharing CO Plus as a function of the underlying value.

### SUMMARY OF THE INVENTION

In one aspect, the invention is a method, system and computer program for achieving advantages from cooperatively investing. This method consists of a number of steps to be taken in order to do this in a clear and non-ambiguous manner. This process, as applied to the CO Option, the alternative for the butterfly option spread, consists basically of the following steps.

First, the individual price-ranges in which the investor can invest, the so-called CO Option Price Ranges, are chosen by the system operators, and announced on a website. After the announcement of the price-ranges and until the closing of the subscription period, the individual investors are allowed to enter on a website the amounts for which they are willing to participate, and to select the price-range in which they are willing to invest. Upon termination of the subscription period, a calculation of the cumulative invested amount per CO Option price-range is done.

From this amount follows the determination, pro rata, of the number of the plain vanilla butterfly spreads that can be bought for the amounts the investors have entered in total. For each plain vanilla butterfly spread it is determined how many underlying options positions have to be bought or sold, for instance on the exchange. Within the total option position, certain option positions have to be bought and sold simultaneously. For that reason a netting process takes place, which means that only the net amount is bought or sold in the market. After the trade is done, the cooperative position and the price per unit of the CO Option are known. The investors receive their statements and their accounts will be credited with the actual positions in CO Options that have been bought with their investments.

The closing of the CO Options will occur automatically with the expiration of the option series. Here, an important element is the cash settlement upon expiration of the underlying options positions. Each CO Options price-range has a different value with expiration. The price range in which the expiration ended has the highest value. The other price-ranges have less or no value.

For the CO Plus, an example of a CO Option, the system, method and computer program provides for sharing the revenue from the expiration of the option positions. This consists of a method in which individual investors agree in advance to forgo some of their gains resulting from a specific market condition in order to compensate other investors who would in this market condition lose part or all of their investment. This specific type of redistribution is possible because the different products are mutually excluding, i.e. they each generate revenue from different market circumstances at the expiration of the option position. The essence of the innovation here is that investors do not need to pay a premium in advance towards investment protection. This mechanism allows them to pay their investment protection premium afterward, and only when their investment is profitable. The investment protection for those investors who suffer losses is possible to the extent that enough other investors are successful.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 illustrates the Cooperative philosophy underlying the present invention

FIGS. 2a, 2b illustrate the specifics of the butterfly option combination graphically

FIG. 3 illustrates the netting matrix

FIG. 4 illustrates the mechanism for cooperative investing

FIG. 5 illustrates the mechanism for revenue sharing

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

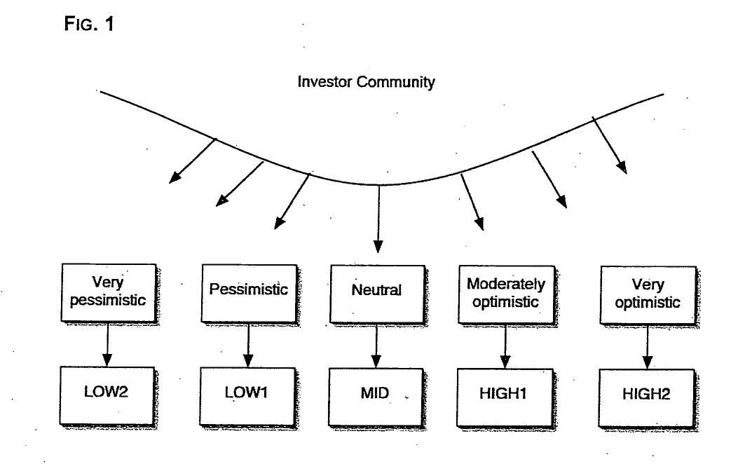

FIG. 1 Illustrates the Cooperative Philosophy Underlying the Present Invention

This figure provides the philosophy of the product. It starts from the assumption that each investor has a vision of at which value the underlying value, i.e. an index like the AEX or the S&P 500, will expire in the next options expiration. The invention brings these different investment views and actions together and allows individual investors to take advantage of investing cooperatively while adhering to their own investment ideas. The figure shows a range from very pessimistic to very optimistic, which estimated results are translated into the expectations utilized within the investment model.

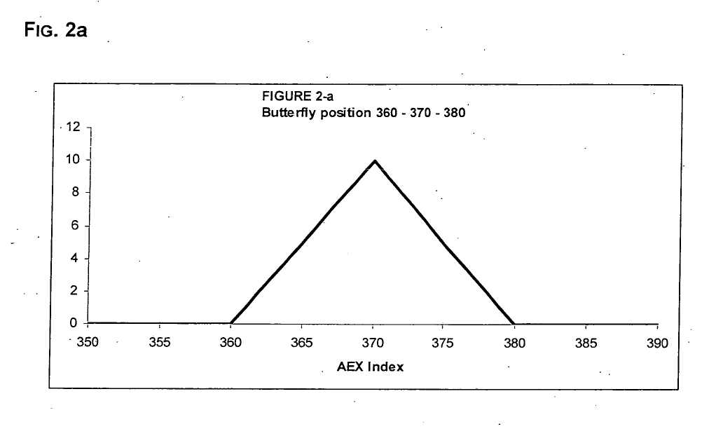

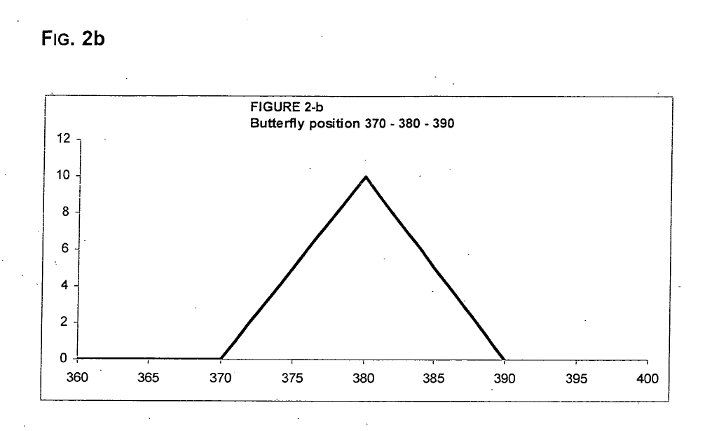

FIG. 2 Illustrates Butterfly Graphics and Specifications

The so-called butterfly is an option combination that is suited for range-bound investment strategies. It can be bought on the options exchanges, but as mentioned earlier this is difficult and mostly expensive for smaller investors. When an investor buys one butterfly (presumably with call options, it can also be done in put options), he or she buys, in effect, one contract with a given exercise price, sells 2 contracts at a higher exercise price and again buys another at an even higher exercise price. An important aspect is that the two differences between the three exercise prices need to be equal. This is generally not a problem with exchange-traded options as many option series are available.

Equally important is that the option contracts have the same expiration date and time. Naturally, being dealt with here are different options series with an identical underlying value. Although not illustrated here, another aspect of the invention is that similar positions can be constructed with put options.

FIG. 2a Illustrates the 360-370-380 Butterfly Spread

In this example, the investor buys one 360 call, sells two 370 calls, and buys one 380 call. The revenue at expiration of the calls is plotted in FIG. 2. The figure shows the revenue potential of the call butterfly. It is noted that the revenue at expiration of the option can be depicted as a roof-like pattern, with the highest point located at the exercise price of the option that the investor has sold.

As shown, the butterfly creates positive revenue if the underlying index is between the lowest and the highest exercise price on expiration day. In the current example this means if the index is between 360 and 380. The maximum possible revenue occurs when the index is exactly at the middle exercise price at the expiration date. Here, this means if the index is exactly at 370.

Furthermore, at no point in the graph is the revenue at expiration negative. The investor only loses from an investment in a butterfly if its value at expiration is lower than the cost. So, as long as the underlying value remains sufficiently within the boundaries, the investor has a profit. If the underlying value shows volatility before expiration of the position, it may move outside the boundaries in which case the investor experiences the loss of his or her investment.

FIG. 2b Illustrates the 370-380-390 Butterfly Spread

To get a position in this butterfly, the investor has to buy the 370 call, sell twice the 380 call and buy the 390 call. In FIG. 2b, the pay-off schedule of this butterfly is shown. The same description as in the above example can suffice here, with the only difference being that the whole schedule is shifted to the right by 10 points. In Table 1, the options positions bought in these two examples are shown side-by-side.

TABLE 1

| | Position Investor 1 | Position Investor 2 |
|---|---|---|
| 360 Call | 1 | |
| 370 Call | −2 | 1 |
| 380 Call | 1 | −2 |
| 390 Call | | 1 |

It can be seen, that Investor 1 is going to buy the 380 call that Investor 2 is going to sell. Additionally, Investor 1 is going to sell the 370 call that Investor 2 is going to buy. By cooperatively investing in butterflies it is possible to net these positions and achieve lower costs.

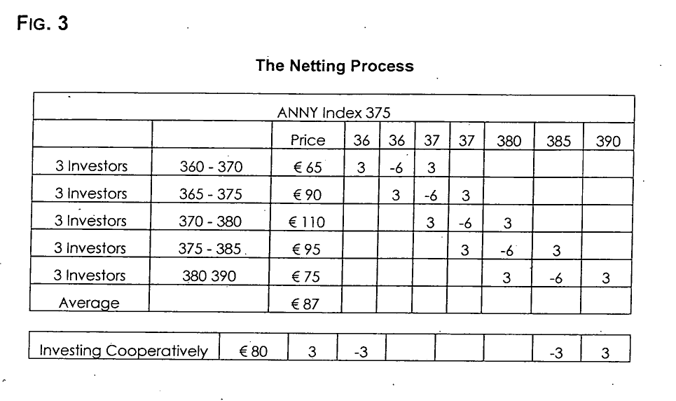

FIG. 3

In this figure we show a stylized example of how netting takes place in practice. In this example, we have 15 investors each having one butterfly in five different positions. For this example they all buy positions that are equal in size. The ranges of the butterfly positions are sequential to one another, and partly overlapping. In the third column from the right, the price is shown for the respective butterfly. If each investor would individually enter the market, he or she would need to trade 4 contracts. In total, all 15 investors would need to trade 15×4, or a total of 60 contracts.

In the bottom row of FIG. 3, in contrast, if the investors would devise a construction to enter the market as a collective, they would only need to trade 12 contracts (4×3). Thus, in this stylized example, the cooperation of investors would yield a saving of 80% in terms of a reduced number of contracts to be traded. This reduction of contracts to trade results in lower brokerage/exchange costs and fewer bid-ask spreads to pay to the market makers on the exchange. This invention provides a mechanism for the individual investor so they can take advantage of a cooperative scheme such as the one illustrated in FIG. 3.

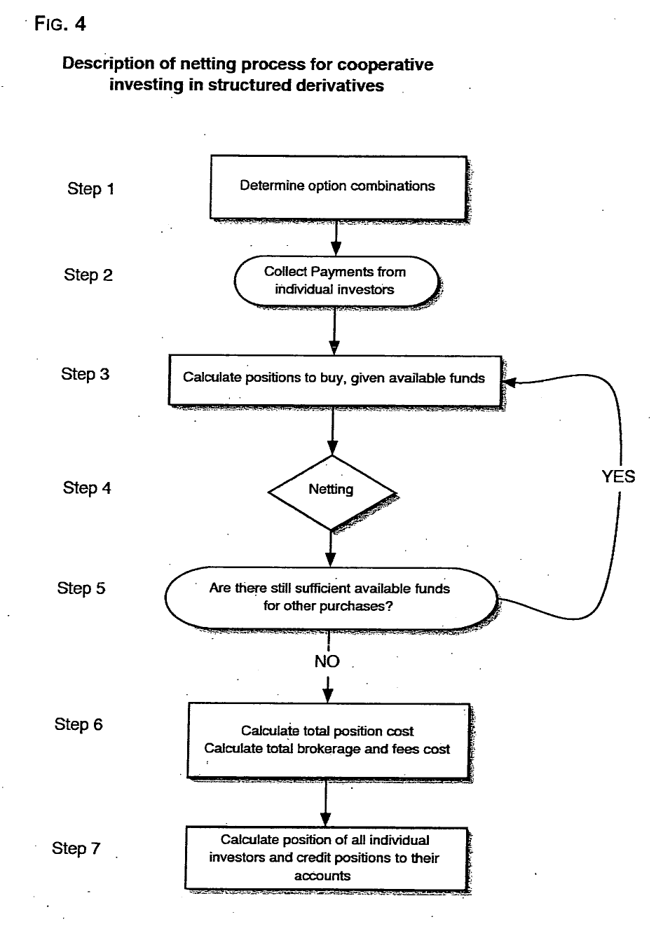

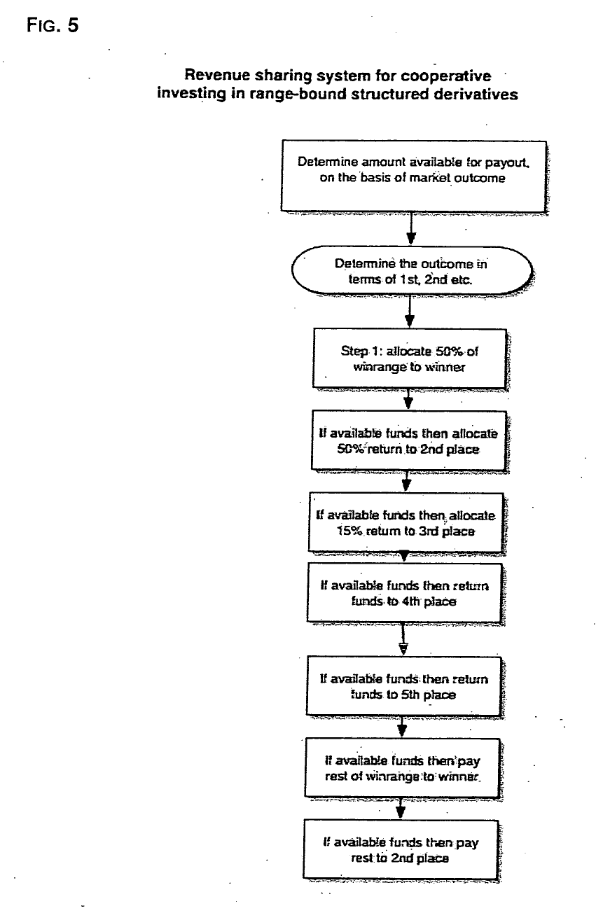

FIG. 4

This figure provides the overall picture of how the investment process is organized and how netting advantages are achieved. The explanation of the figure concentrates on the butterfly as the investment product that the cooperative is collectively buying. All of the investors here are essentially buying butterflies.

Step 1, the operator of the system announces the CO Options Price ranges available for investment on the basis of an assessment of the current market conditions. (See FIG. 1) This includes, but is not limited to, an assessment as to what the current market value is of the underlying security or index as well as an assessment of the expected volatility until the next or the relevant option expiration. In the case of butterflies, this means that the cooperative has to decide which ranges are offered for subscription to individual investors. Here the cooperative would also have to take the availability of particular option series into account.

Step 2, the structured option positions are announced as securities on the website of the system operator and a subscription process is launched so individual investors can subscribe to these securities. In this step, the investors have two choices, either the CO Options with the revenue sharing, named CO Plus, or the CO Single with essentially the same instruments but without the added element of revenue sharing. Hence, for all the available instruments two separate subscriptions are opened. The subscription is managed on the basis of the total amount of money that is subscribed instead of the number of contracts, shares or certificates. The amount subscribed is temporarily blocked from other use in the investor account.

Step 3, when the subscription is closed, for all instruments the total invested amounts are determined and the temporarily blocked funds are transmitted to the cooperative account. For the purposes of the netting process, the totals of the respective products with or without revenue sharing are combined. This is possible because the same structured option products underlie the separately managed subscriptions. Given these total amounts and the market prices of the option combinations the respective amounts available to buy the individual products can be calculated.

Step 4, the netting takes place. (See FIG. 3) This step consists of a few sub-steps. First, the positions in structured option products that are to be bought are translated into positions of individual options series. Second, the amounts in every series are added over all the amounts. Since some negative series are added to positive series, this means that fewer option series have to be purchased on the exchange. This essentially constitutes the netting advantage, since the bid-ask spread in the options market can be avoided for a large percentage of the trades.

Step 5, as a positive result of the netting process, funds may still be sufficient to buy more positions. But first the brokerage/exchange costs are deducted from the remaining amount. Additional positions are bought from the remaining amount. Naturally, these are bought again in proportion to the investments in the original respective products. This means a return to the 3^{rd} step. If funds are insufficient for additional purchases, the process continues to the 6^{th} step.

Step 6, if the available funds are insufficient to buy additional options positions, the total transaction costs need to be recalculated. These are essentially a summation of the costs that are calculated in each of the previous steps.

Step 7, if all the costs have been taken into account, a calculation is made to determine the positions of all the individual investors that should be put in their accounts for the amount they invested. This is done on a pro rata basis.

The innovative essence here is that individual investors can hold fractional positions. Hence, if their investment in a particular series of a CO Option is not sufficient for a purchase of one unit, they can still invest and a fraction of one unit of a CO Option is credited to their account upon purchase. After completion of these steps, all participants can monitor their positions by accessing their accounts through the Internet. The operator of the system can arrange for the participants to sell the option before the expiration, but it is not an essential aspect of this invention.

In the following, the cooperative buying process in the butterfly case is illustrated step-by-step. In this example, specific numbers are entered for the investments made by the participants. All the necessary calculations are shown. The underlying value upon which the example structured option products are based is the fictional stock index called ANNY.

We define 10 individual investors, half of whom have ε100,000 in their respective individual accounts and the other half have ε50,000. They all invest 10% of the balance in their accounts in the initial period, so half of them invest ε10,000 and half ε5,000. Thus, in total 5×ε10,000+5×ε5,000=ε75,000 is invested in the initial period.

The operator announces in this example 5 price ranges of the ANNY-index available for subscription. These are the Low2, the Low1, the Mid, the High1 and the High2. More or fewer price ranges can be defined in this method. This may depend on factors such as the volatility of the underlying value, the available strike prices and demands or feedback from market participants. The basic rule for the determination of these price ranges is that the so-called Mid price range is the range where the midpoint of that range is the closest to the given settlement price of the underlying value.

Determination of the price ranges is also influenced by the volatility of the underlying value, the time period until expiration of the CO Options, the available strike prices traded on the exchanges and demand by or feedback from the participants. The price ranges are, in this example, first based on a given settlement price of the ANNY-index. This may, for example, be a daily closing price, or the settlement price of the last expiration of the option series on the ANNY-index. Here, the expiration value for the June 2005 call and puts is taken. This expiration value for the ANNY-index was 381.67. Given this value, ranges for the next subscription for Co Singles and Co Pluses are determined. In this example we choose the midpoint of the Mid-range to be as close as possible to the expiration value of the ANNY index. In this case this is 380.

After the choice of the midpoint of the Mid-range, the width of the price range is determined: In this example, considering the above-mentioned factors, we choose a total butterfly range of 10 points. Total butterfly range is the difference between the high end and the low end of the price range. In this example the high end of the Mid-range of the butterfly is 380 plus 5 points, and the low end of the butterfly is 380 less 5 points namely 375. These prices must be traded option series on the exchange.

The midpoint of the Low1-range is half of the total determined price range of the CO Single lower than the midpoint of the Mid-range. In this example the midpoint of the Low1-range is 375. The midpoint of the Low2-range is half of the total determined price range of the CO Single lower than the midpoint of the Low1-range. In this example the midpoint of the Low2-range is 370. The midpoint for the High1-range is half of the total determined price range of the CO Single higher than the midpoint of the Mid-range. In this example the midpoint of the High1-range is 385. The midpoint for the High2-range is half of the total determined price range of the CO Single higher than the midpoint of the High1-range. In this example the midpoint of the High1-range is 390.

Next, for each of the CO Singles the necessary high end and low-end prices are determined. For CO Singles with a 10-point range, the outer strike prices should be 5 points from the midpoint. Thus, for the Mid-range, with a midpoint of 380 the outer strike prices are 375 for the low end and 385 for the high end. Thus, for the Low 1 price range, with a midpoint of 375 the outer strike prices are 370 for the low end and 380 for the high end. Thus, for the Low 2 price range, with a midpoint of 370 the outer strike prices are 365 for the low end and 375 for the high end. Thus, for the High 1 price range, with a midpoint of 385 the outer strike prices are 380 for the low end and 390 for the high end. Thus, for the High 2 price range, with a midpoint of 390 the outer strike prices are 385 for the low end and 395 for the high end. Summarizing, the 7 low end, mid and high-end strike prices from 365 to 395 with an interval of 5 points are selected for setting up the total Cooperative position.

Subsequently, the information of the options exchange is checked by the Operator to determine whether all the necessary option series are available. Although this is not likely to be a problem in most cases, the ranges might have to be adjusted if certain series are not available.

For the CO Plus, which has a CO Single as its basis, the same contracts are traded as for the CO Single. Thus, the total price ranges, in terms of the Low End and the High End strike prices are equal. However, the price ranges are subsequently redefined in order to make the inner ranges of the CO Plus price ranges mutually exclusive, or non-overlapping. This is done by defining an inner half of the range, divided equally around the midpoint of the total range. For the Mid-range, given by 375-380-385 for the CO Single, this results in the Co Plus inner range of 377.50-382.50. The other inner ranges are 367.50-372.50 for the Low2-range, 372.50-377.50 for the Low1-range, 382.50-387.50 for the High1-range and, finally, 387.50-392.50 for the High2-range.

Table 2 gives an overview of all the available ranges for both the CO Single and the CO Plus.

TABLE 2

| CO Single | Low End | Midpoint | High End |
|---|---|---|---|
| Low 2 | 365 | 370 | 375 |
| Low 1 | 370 | 375 | 380 |
| MID | 375 | 380 | 385 |
| High 1 | 380 | 385 | 390 |
| High 2 | 385 | 390 | 395 |

| Co Plus | Low End | Inner Range | High End |
|---|---|---|---|
| Low 2 | 365 | 367.50-372.50 | 375 |
| Low 1 | 370 | 372.50-377.50 | 380 |
| MID | 375 | 377.50-382.50 | 385 |
| High 1 | 380 | 382.50-387.50 | 390 |
| High 2 | 385 | 387.50-392.50 | 395 |

Now that the price ranges have been specified, the ranges are opened for subscription by individual investors. As indicated above, the total amount for which investors subscribe is ε15000 for each range, comprising ε10000 for the product with revenue redistribution, the CO Plus and ε5000 for the plain-vanilla product, the CO Single.

During this subscription stage, the investors submit their investment choice into the system through the website, which is connected to the software application. They subscribe to an amount of money, instead of a quantity as is common with exchange-traded investments products. The funds amount is blocked on their account. The amount to which individual investors subscribe can be subject to a maximum and/or a minimum per price range, to be decided by the operator. Also, the total amounts per price range can be subject to a maximum and/or a minimum per price range, to be decided by the operator. The duration of the subscription period can vary. It may be a specified number of days, weeks or hours. Upon expiration of the subscription period, the operator uses the software to review all the commitments made by the participants within the system. The blocked amounts are transferred to the cooperative account. These are instantly available through the system.

For the cooperative buying process, all the subscriptions per price range are added up, regardless whether the participants have chosen the product with or without profit distribution. This is because the options combinations to buy for both the CO Single and the CO Plus are the same. Thus, following this example, the total invested sums per range are as follows:

TABLE 3

| Invested Amount Per | | | |
|---|---|---|---|
| Product and Per Range | CO Single | Co Plus | Total |
| Low2 | 5000 | 10000 | 15000 |
| Low1 | 5000 | 10000 | 15000 |
| MID | 5000 | 10000 | 15000 |
| High1 | 5000 | 10000 | 15000 |
| High2 | 5000 | 10000 | 15000 |
| Total Invested | 25000 | 50000 | 75000 |

Following this, a calculation takes place as to how many positions in the respective butterfly positions can be bought for these amounts. This process is repeated step-by-step. Additional inputs for this calculation are the market prices for these butterflies. This is done by looking up the market prices for the butterflies through market data providers. Here, only the bid and ask prices are needed, as these prices indicate prices at which investors can trade in the market. In this example, we use the following bid and ask prices for the ANNY-index:

TABLE 4

| Option | | |
|---|---|---|
| Series | Bid | Ask |
| July 365 Call | 16 | 16.25 |
| July 370 Call | 11.55 | 11.7 |
| July 375 Call | 7.55 | 7.65 |
| July 380 Call | 4.3 | 4.45 |
| July 385 Call | 2.1 | 2.2 |
| July 390 Call | 0.9 | 0.95 |
| July 395 Call | 0.35 | 0.4 |

An investor who buys one butterfly combination in the option markets, conducts the following transactions simultaneously or consecutively (although not necessarily in this order):
Buy the low-end option once
Sell the midpoint option twice
Buy the high-end option once

Thus, from the above market bid and ask prices, the indicative prices for the butterflies can be calculated. This is done in the following manner:

For the Low2-range, the indicative price is:
the ask price of the July 365 Call−/−
2×the bid price of the July 370 Call+/+ the ask price of the July 375 Call.

For this example the calculation is:
16.25×1−/−11.55×2+/+7.65×1=ε0.80

For the Low1-range, the indicative price is:
the ask price of the July 370 Call−/−
2×the bid price of the July 375 Call+/+ the ask price of the July 380 Call.

In this example the calculation is:
11.7×1−/−7.55×2+/+4.45×1=ε1.05

For the Mid-range, the indicative price is:
the ask price of the July 375 Call−/−
2×the bid price of the July 380 Call+/+ the ask price of the July 385 Call.

In this example the calculation is:
7.65×1−/−4.30×2+/+2.20×1=ε1.25

For the High1-range, the indicative price is:
the ask price of the July 380 Call−/−
2×the bid price of the July 385 Call+/+ the ask price of the July 390 Call.

In this example the calculation is:
4.45×1−/−2.10×2+/+0.95×1=ε1.20

For the High2-range, the indicative price is:
the ask price of the July 385 Call−/−
2×the bid price of the July 390 Call+/+ the ask price of the July 395 Call.

In this example the calculation is:
2.20×1−/−0.90×2+/+0.40×1=ε0.80

Market prices are quoted in units. However, option contracts have almost always a contract size bigger than one unit. The most common contract size is 100 units. Thus, all prices are multiplied by 100 below.

After the necessary calculations are done, the following table shows the indicative prices for the butterflies:

TABLE 5

| Range | | Indicative Butterfly Price |
|---|---|---|
| Low2 | 365-370-375 | [symbol] 80 |
| Low1 | 370-375-380 | [symbol] 105 |
| MID | 375-380-385 | [symbol] 125 |
| High1 | 380-385-390 | [symbol] 120 |
| High2 | 385-390-395 | [symbol] 80 |

This table with indicative prices is used as the basis for the buying process. The positions that are to be bought are calculated in a few steps. In each step, the amount that is to be invested is divided by the price of the respective butterfly position. Then, these positions are netted over all the strike prices.

Thus, in step 1, the amounts are divided by the respective prices:

TABLE 6

| | | | Indicative | Butterflies |
|---|---|---|---|---|
| Price Range | | Amount | Butterfly Price | to Buy |
| Low2 | 365-370-375 | [symbol] 15000 | [symbol] 80 | 188 |
| Low1 | 370-375-380 | [symbol] 15000 | [symbol] 105 | 143 |
| Mid | 375-380-385 | [symbol] 15000 | [symbol] 125 | 120 |
| High1 | 380-385-390 | [symbol] 15000 | [symbol] 120 | 125 |
| High2 | 385-390-395 | [symbol] 15000 | [symbol] 80 | 188 |

These numbers are rounded to the nearest integer number so they result in an integer number of option contracts. The remainder of this rounding procedure is kept for use in subsequent steps. In the next step, these positions in butterflies are translated into positions of individual option series. This is again shown in the table, which also shows how trades in option series cancel each other out in a netting process. The options to buy are netted against the ones to sell.

TABLE 7

| | | July 365 | July 370 | July 375 | July 385 | July 385 | July 390 | July 395 | |
|---|---|---|---|---|---|---|---|---|---|
| Price Range | | Call | Call | Call | Call | Call | Call | Call | Total |
| Low2 | 365-370-375 | 188 | −376 | 188 | | | | | 0 |
| Low1 | 370-375-380 | | 143 | −286 | 143 | | | | 0 |
| MID | 375-380-385 | | | 120 | −240 | 120 | | | 0 |
| High1 | 380-385-390 | | | | 125 | −250 | 125 | | 0 |
| High2 | 385-390-395 | | | | | 188 | −376 | 188 | 0 |

| | | | | | | | | |
|---|---|---|---|---|---|---|---|---|
| Total Option Trade | 188 | −233 | 22 | 28 | 58 | −251 | 188 | 0 |
| Gross Total Contracts | 188 | 519 | 594 | 508 | 558 | 501 | 188 | 3056 |
| Netting Total | 188 | 233 | 22 | 28 | 58 | 251 | 188 | 968 |

The row “total option trade” can then be considered as an option trade that could be entered into the market. The last two rows of this table clearly show the advantage of netting. The “Gross Total” row shows how many option contracts would be needed if investors were trading on an individual basis. The total amount is 3056 contracts.

By acting cooperatively, only 968 would be needed, a reduction of 68%. The total price paid by the cooperative for the total option trade is the amount achieved by a multiplication of the “total” row in the table with the appropriate bid or ask price. This is illustrated in the following table:

TABLE 8

| | Position to | Option | Market | Amount | |
|---|---|---|---|---|---|
| Option Series | Buy/Sell | Price | Side | Receive | Paid |
| July 365 Call | 188 | [symbol] 1625 | ASK | | [symbol] 305500 |
| July 370 Call | −233 | [symbol] 1155 | BID | [symbol] 269115 | |
| July 375 Call | 22 | [symbol] 765 | ASK | | [symbol] 16830 |
| July 385 Call | 28 | [symbol] 445 | ASK | | [symbol] 12460 |
| July 385 Call | 58 | [symbol] 220 | ASK | | [symbol] 12760 |
| July 390 Call | −251 | [symbol] 90 | BID | [symbol] 22590 | |
| July 395 Call | 188 | [symbol] 40 | ASK | | [symbol] 7520 |
| Total | 0 | | | [symbol] 291705 | [symbol] 355070 |

| | |
|---|---|
| Total Price of the Option Trade: | [symbol] 63365 |

If a long position is taken in the respective option series, it is multiplied with the ask price. If a short position is taken, it is multiplied with the bid. This results in an amount to be paid of ε63,365.

As shown in this table, the netting process in this transaction results in a significant savings. The same position that would have cost ε75,000 if investors had acted individually, now only costs ε63,365. This is mainly the result of there being fewer market bid-ask spreads. This saving can be used to increase the position. So the remainder of the investment, ε11,635, or 15.5% of the original amount (ε75,000) is still available for additional purchases on the options exchange. After calculating how many options can be bought in this first step, the associated costs with this trade are assessed. This amount is then subtracted from the total amount still available for investment.

In this example, the following costs should be reckoned with at this stage: broker fees and exchange fees. In total, these are assumed to be ε1.25 per option contract. Since 968 contracts are added to the trade in this step, the broker fees are ε1210 thus far. After adjusting the available amount for this, an amount of 11,635−/−1210=ε10,425 is used for the next buying step.

This step takes place in the identical manner as the first step. First, the available funds are subdivided over the ranges according to the same ratio as in the original case.

This results in a similar table as above:

TABLE 9

| Invested Amount | | | |
|---|---|---|---|
| per Product/per | | | |
| Range | CO Single | CO Plus | Total |
| Low2 | [symbol] 695 | [symbol] 1390 | [symbol] 2085 |
| Low1 | [symbol] 695 | [symbol] 1390 | [symbol] 2085 |
| MID | [symbol] 695 | [symbol] 1390 | [symbol] 2085 |
| High1 | [symbol] 695 | [symbol] 1390 | [symbol] 2085 |
| High2 | [symbol] 695 | [symbol] 1390 | [symbol] 2085 |
| Total invested | [symbol] 3475 | [symbol] 6950 | [symbol] 10425 |

Since the amounts in the original case were equal, equal amounts are again invested in each of the ranges and products. Thus, in this step, in each butterfly, an extra amount of ε2085 is invested in each butterfly.

In the subsequent step, this amount is again divided by the respective prices, which results in the following table. The remainder of the same calculation in step 1 in Table 6 above is shown in the second column from the right. The amount of butterflies to buy in the last column is adjusted for this number, and is again rounded off resulting in an integer amount. The remainder is again stored to be used in subsequent steps.

TABLE 10

| | | | | Fractions | |
|---|---|---|---|---|---|
| | | | Indicative | from | Butter- |
| | | | Butterfly | Previous | flies |
| Price Range | | Amount | Price | Step | to Buy |
| Low2 | 365-370-375 | [symbol] 2085 | [symbol] 80 | −0.5 | 26 |
| Low1 | 370-375-380 | [symbol] 2085 | [symbol] 105 | −0.1429 | 20 |
| MID | 375-380-385 | [symbol] 2085 | [symbol] 125 | 0 | 17 |
| High1 | 380-385-390 | [symbol] 2085 | [symbol] 120 | 0 | 17 |
| High2 | 385-390-395 | [symbol] 2085 | [symbol] 80 | −0.5 | 26 |

From the amounts of butterflies to buy in the options exchange, the netting table can again be derived.

TABLE 11

| | | July 365 | July 370 | July 375 | July 385 | July 385 | July 390 | July 395 | |
|---|---|---|---|---|---|---|---|---|---|
| Price Range | | Call | Call | Call | Call | Call | Call | Call | Total |
| Low2 | 365-370-375 | 26 | −52 | 26 | | | | | 0 |
| Low1 | 370-375-380 | | 20 | −40 | 20 | | | | 0 |
| MID | 375-380-385 | | | 17 | −34 | 17 | | | 0 |
| High1 | 380-385-390 | | | | 17 | −34 | 17 | | 0 |
| High2 | 385-390-395 | | | | | 26 | −52 | 26 | 0 |

| | | | | | | | | |
|---|---|---|---|---|---|---|---|---|
| Total Option Trade | 26 | −32 | 3 | 3 | 9 | −35 | 26 | 0 |
| Gross Total Contracts | 26 | 72 | 83 | 71 | 77 | 69 | 26 | 424 |
| Netting Total | 26 | 32 | 3 | 3 | 9 | 35 | 26 | 134 |

As in the previous netting table, the row “Total option trade” can again be seen as an option trade to be entered into the market. Again, the amounts in this row are multiplied by the market prices of the respective options in the same manner, i.e. long positions with the ask price and short positions with the bid price.

TABLE 12

| | Position to | Option | Market | Amount | |
|---|---|---|---|---|---|
| Option Series | Buy/Sell | Price | Side | Receive | Paid |
| July 365 Call | 26 | [symbol] 1625 | ASK | | [symbol] 42,250 |
| July 370 Call | −32 | [symbol] 1155 | BID | [symbol] 36960 | |
| July 375 Call | 3 | [symbol] 765 | ASK | | [symbol] 2,295 |
| July 385 Call | 3 | [symbol] 445 | ASK | | [symbol] 1,335 |
| July 385 Call | 9 | [symbol] 220 | ASK | | [symbol] 1,980 |
| July 390 Call | −35 | [symbol] 90 | BID | [symbol] 3150 | |
| July 395 Call | 26 | [symbol] 40 | ASK | | [symbol] 1,040 |
| Total | 0 | | | [symbol] 40110 | [symbol] 48900 |

| | |
|---|---|
| Total Price of the Option Trade: | [symbol] 8790 |

This results in an amount to be paid of ε8790.

After this step, the fees attributed to this trade are again assessed. The extra costs associated with this step are ε1.25 per contract times the number of contracts 134, which equals ε167.50. Then, the trade total of ε8,790 and the associated transactions cost of ε167.50 are subtracted from the previous total available amount of ε10,425. Subsequently, ε1467.50 is left for additional purchases. This amount is again subdivided pro rata over all the ranges in the table:

TABLE 13

| Invested Amount | | | |
|---|---|---|---|
| per Product/per | | | |
| Range | CO Single | CO Plus | Total |
| Low2 | [symbol] 97.83 | [symbol] 195.67 | [symbol] 293.50 |
| Low1 | [symbol] 97.83 | [symbol] 195.67 | [symbol] 293.50 |
| MID | [symbol] 97.83 | [symbol] 195.67 | [symbol] 293.50 |
| High1 | [symbol] 97.83 | [symbol] 195.67 | [symbol] 293.50 |
| High2 | [symbol] 97.83 | [symbol] 195.67 | [symbol] 293.50 |
| Total invested | [symbol] 489.17 | [symbol] 978.33 | [symbol] 1,467.50 |

Next, the calculation is repeated to determine how many butterflies can be bought for these amounts. This is done by dividing the amounts available in every range by the indicative price for the respective butterflies. The resulting non-rounded number should then be adjusted to include the fractions from the previous step. The resulting figure is then rounded to result in an integer number of butterflies to be traded.

TABLE 14

| | | | | Fractions | |
|---|---|---|---|---|---|
| | | | Indicative | from | Butter- |
| | | | Butterfly | Previous | flies |
| Price Range | | Amount | Price | Step | To Buy |
| Low2 | 365-370-375 | [symbol] 293.50 | [symbol] 80 | −0.4375 | 3 |
| Low1 | 370-375-380 | [symbol] 293.50 | [symbol] 105 | −0.28571 | 3 |
| MID | 375-380-385 | [symbol] 293.50 | [symbol] 125 | −0.32 | 2 |
| High1 | 380-385-390 | [symbol] 293.50 | [symbol] 120 | 0.375 | 3 |
| High2 | 385-390-395 | [symbol] 293.50 | [symbol] 80 | −0.4375 | 3 |

From these data, the netting table can again be derived.

TABLE 15

| | | July 365 | July 370 | July 375 | July 385 | July 385 | July 390 | July 395 | |
|---|---|---|---|---|---|---|---|---|---|
| Price Range | | Call | Call | Call | Call | Call | Call | Call | Total |
| Low2 | 365-370-375 | 3 | −6 | 3 | | | | | 0 |
| Low1 | 370-375-380 | | 3 | −6 | 3 | | | | 0 |
| MID | 375-380-385 | | | 2 | −4 | 2 | | | 0 |
| High1 | 380-385-390 | | | | 3 | −6 | 3 | | 0 |
| High2 | 385-390-395 | | | | | 3 | −6 | 3 | 0 |

| | | | | | | | | |
|---|---|---|---|---|---|---|---|---|
| Total Option Trade | 3 | −3 | −1 | 2 | −1 | −3 | 3 | 0 |
| Gross Total Contracts | 3 | 9 | 11 | 10 | 9 | 12 | 6 | 60 |
| Netting Total | 3 | 3 | 1 | 2 | 1 | 3 | 3 | 16 |

An additional 16 contracts are added to the trade. As in the previous netting table, the row “Total option trade” can again be seen as an option trade to be entered into the market. Again, the amounts in this row are multiplied by the market prices of the respective options in the same manner, i.e. long positions with the ask price and short positions with the bid price. This results in an amount to be paid of ε1,165. This is shown in Table 16.

TABLE 16

| | Position to | Option | Market | Amount | |
|---|---|---|---|---|---|
| Option Series | Buy/Sell | Price | Side | Receive | Paid |
| July 365 Call | 3 | [symbol] 1625 | ASK | | [symbol] 4,875 |
| July 370 Call | −3 | [symbol] 1155 | BID | [symbol] 3,465 | |
| July 375 Call | −1 | [symbol] 755 | ASK | [symbol] 755 | |
| July 385 Call | 2 | [symbol] 445 | ASK | | [symbol] 890 |
| July 385 Call | −1 | [symbol] 220 | ASK | [symbol] 210 | |
| July 390 Call | −3 | [symbol] 90 | BID | [symbol] 270 | |
| July 395 Call | 3 | [symbol] 40 | ASK | | [symbol] 120 |
| Total | 0 | | | [symbol] 4,700 | [symbol] 5,885 |

| | |
|---|---|
| Total: | [symbol] 1,185 |

After this step, the associated costs with this trade are again assessed. The extra costs associated with this step are ε1.25 per contract times the number of contracts 16, which equals ε20. Subsequently the trade total ε1,185, as well as the transactions costs in this step are subtracted from the previous total available amount of ε1,467.50. Only ε262.50 is then left remaining for additional purchases, or ε52,50 for each individual range. Since ε52.50 is insufficient for buying a complete individual butterfly, no further action is taken to increase the positions. Now, all the results from the netting tables in the various steps are added up. This results in the following combined option order:

TABLE 17

| | Trade | Trade | Trade | Trade | |
|---|---|---|---|---|---|
| Option Series | Step1 | Step2 | Step3 | Step4 | Total Option Trade |
| July 365 Call | 188 | 26 | 4 | 0 | 217 |
| July 370 Call | −233 | −32 | −5 | 0 | −268 |
| July 375 Call | 22 | 3 | 0 | 0 | 24 |
| July 385 Call | 28 | 3 | 1 | 0 | 33 |
| July 385 Call | 58 | 9 | 2 | 0 | 66 |
| July 390 Call | −251 | −35 | −6 | 0 | −289 |
| July 395 Call | 188 | 26 | 4 | 0 | 217 |

This order is given by the operator to a broker who executes the order in the market, and puts the positions in the cooperative depot.

In the event the operator is a Cooperative Exchange, the exchange facilitates for the investors with buying the option positions on the exchange by, for instance, an auction. After the order is executed on the exchange, the actual paid amount is determined. On the basis of this amount, the cost price per option series and per butterfly can be calculated.

In this example we assume that the assumed market bid or ask prices have been paid for each option series. In that case, the following total amount is paid: ε73385. Including transaction costs, the amount is ε74790. With this amount, a calculation takes place to determine the price that is paid for each butterfly.

To do this, the invested amounts in all the ranges are divided by the total positions in the respective butterflies. For this purpose, the CO Singles and the CO Plus positions are taken together. First, we show the table with the total butterfly positions:

TABLE 18

| Price Range | | Step1 | Step2 | Step3 | Step 4 | Total |
|---|---|---|---|---|---|---|
| Low2 | 365-370-375 | 188 | 26 | 3 | 0 | 217 |
| Low1 | 370-375-380 | 143 | 20 | 3 | 0 | 166 |
| Mid | 375-380-385 | 120 | 17 | 2 | 0 | 139 |
| High1 | 380-385-390 | 125 | 17 | 3 | 0 | 145 |
| High2 | 385-390-395 | 188 | 26 | 3 | 0 | 217 |

Next, the total invested amounts per range are taken together in order to determine the average price paid per butterfly. In this example, this calculation results in the following average price table:

TABLE 19

| | | | | | | | Average |
|---|---|---|---|---|---|---|---|
| | | | | | Total | Invested | price per |
| Price Range | | Step1 | Step2 | Step3 | Position | amount | butterfly |
| Low2 | 365-370-375 | 188 | 26 | 3 | 217 | 15000 | 69.1244 |
| Low1 | 370-375-380 | 143 | 20 | 3 | 166 | 15000 | 90.3614 |
| Mid | 375-380-385 | 120 | 17 | 2 | 139 | 15000 | 107.9137 |
| High1 | 380-385-390 | 125 | 17 | 3 | 145 | 15000 | 103.4438 |
| High2 | 385-390-395 | 188 | 26 | 3 | 217 | 15000 | 69.1244 |

The transaction costs of the cooperation, the broker fees and the exchange fees are implicitly included in these average prices. Table 20 provides a calculation to determine how many of these costs are included per contract.

TABLE 20

| | |
|---|---|
| Total Transaction Costs | [symbol] 1397.50 |
| Total Traded Butterflies | 884 |
| Transaction Costs per COSI or per COPL | 1.5809 |

After the buying process is finished, and the additional calculations have taken place, the positions are credited to the accounts of the participants. The following is an example of a position statement of an individual investor in a CO Plus.

TABLE 21

| Name | Jones, J. |
|---|---|
| Amount Subscribed to | 500 |
| Provision | 24 |
| Net Invested Amount | 476 |
| Member no. | 1234 |
| Co Plus ANNY-index Price Range | 370-380 |
| Price per Co Plus | [symbol] 90.3614 |
| Of which Fees | [symbol] 1.5809 |
| Fractions in Portfolio | 5.267736 |

Detailed Description of the Closing Process of the CO Single

In the following example, the closing process for the CO Single, the product without the revenue sharing mechanism, is illustrated in detail. In order to show how the system works in its totality, basically the same numbers are used as in the prior buying example. Additional assumptions are made regarding the outcome of the investment process. For this, the only extra input that is needed for the system here is the expiration value of the underlying value.

In this example, the closing process is straightforward. The revenue is assessed per butterfly combination underlying the CO Singles. Payment follows to the account of participants with a position in the, or one of the, revenue-generating butterflies.

The process starts with the determination of the market outcome, i.e. the expiration price of the ANNY-index. For there to be a positive amount, at least one of the butterflies should expire in-the-money. This is the case if, for at least one of the butterflies, the expiration value of the underlying value is between the low-end price and the high-end price. So in this example this would be the case if the expiration price of the ANNY would be between 365 and 395.

In this case, we assume that the expiration value for the underlying index, the ANNY, is 386. Given this value the expiration value for the position of the cooperation can be calculated. In this example the following table lists the expiration value for all the underlying options of the total cooperative position.

TABLE 22

| Option Series | Position | Call Value | Expiration Value |
|---|---|---|---|
| July 365 Call | 218 | [symbol] 2100 | [symbol] 457800 |
| July 370 Call | −270 | [symbol] 1600 | [symbol] −432000 |
| July 375 Call | 25 | [symbol] 1100 | [symbol] 27500 |
| July 380 Call | 32 | [symbol] 600 | [symbol] 19200 |
| July 385 Call | 69 | [symbol] 100 | [symbol] 6900 |
| July 390 Call | −292 | 0 | 0 |
| July 395 Call | 218 | 0 | 0 |

| | |
|---|---|
| Total | [symbol] 79400 |

The expiration value amounts in the right column sum up to ε79,400, which is the total amount available for the distribution to the participants. Following the determination of the total amount available for distribution to the participants, this is subdivided between the CO Single and the CO Plus. This is done according to the positions that are stored in the system employed by the Operator. The basis for the closing procedure of the CO Single is the total position of the Cooperative invested in CO Singles. In the internal accounting system all of the positions of the CO Single and the CO Plus are stored. In this example there are only 5 investors in the CO Single. Their respective positions are stored in the system employed by the Operator. These positions are shown in Table 23.

TABLE 23
Total Butterfly Position Per Product and Per Range

| | Total Butterfly | | |
|---|---|---|---|
| | Position | CO Single | CO Plus |
| | Price Range | Positions | Position |
| Low2 | 365-370-375 | 72.6667 | 145.3333 |
| Low1 | 370-375-380 | 55.3333 | 110.6667 |
| MID | 375-380-385 | 46.3333 | 92.6667 |
| High1 | 380-385-390 | 48 | 96 |
| High2 | 385-390-395 | 72.6667 | 145.3333 |

The positions as shown in the table are the basis for the closing procedure. Since some of the positions are not integer values, the position numbers have been rounded up to 4 decimal points. It should also be noted that for the specific example here, all the positions shown above are not only cumulative positions but also individual positions. In normal circumstances, cumulative positions consist of a cumulation of individual positions.

TABLE 24

| | | | | Expiration |
|---|---|---|---|---|
| | | Position | Expiration | Value |
| | | Total | Value | CO Single |
| | Price Range | CO Singles | CO Single | Position |
| Low2 | 365-370-375 | 72.6667 | 0 | 0 |
| Low1 | 370-375-380 | 55.3333 | 0 | 0 |
| Mid | 375-380-385 | 46.3333 | 0 | 0 |
| High1 | 380-385-390 | 48 | 400 | [symbol] 19200 |
| High2 | 385-390-395 | 72.6667 | 100 | [symbol] 7266.67 |

| | |
|---|---|
| Total Revenue CO Single | [symbol] 26466.67 |

This table shows the total revenue attributed to the CO Single investors. For individual participants, the revenue from the expiration value of the CO Single can now be calculated.

This is done by multiplying their individual position in CO Singles by the expiration value of the CO Single as indicated in the fourth column in the table.

In this example, as there is only one investor in each of the ranges, this calculation is straightforward and follows directly from the last table. For example, the CO Single investor who had invested in the High2 Range has a position of 72,667 CO Singles in the range 385-390-395. These CO Singles have a final value of ε100. Therefore, this investor's account is credited upon closing of the position with an amount of ε7,266.70, before transactions costs.

The costs of the expiration due from the exchange and brokers in this example are paid by the Operator. These costs must be paid from the percentages of the profit accrued by the participants. The calculation takes place in the following steps.

In this example the model of the operator is that CO Singles provision is due when participants have a profit. The provision is 6% of the profits accrued by the participants.

To calculate the gross profit (before provision), the revenue in a given range has to be compared with the average price per butterfly. Gross profit per butterfly is then multiplied with the position in the respective price range.

TABLE 25

| | | | | Expiration | | |
|---|---|---|---|---|---|---|
| | Average | Position | Expiration | Value CO | | Provision |
| | Price per | Total CO | Value CO | Single | Provision | per CO |
| Price Range | Butterfly | Singles | Single | Position | Cooperative | Single |
| Low2 | [symbol] 68.8073 | 72.66667 | 0 | 0 | 0 | 0 |
| Low1 | [symbol] 90.3614 | 55.33333 | 0 | 0 | 0 | 0 |
| MID | [symbol] 107.9137 | 46.33333 | 0 | 0 | 0 | 0 |
| High1 | [symbol] 104.1667 | 48 | [symbol] 400 | [symbol] 19,200 | [symbol] 852.00 | [symbol] 189.33 |
| High2 | [symbol] 68.8073 | 72.66667 | [symbol] 100 | [symbol] 7,266.667 | [symbol] 136.00 | [symbol] 19.96 |

| | |
|---|---|
| Total Provision charged by the System Operator | [symbol] 988 |

For the investor in the High2 range, the amount credited to his or her account is therefore
ε7266.67−/−136=ε7,130.67
Example of the Revenue Sharing Mechanism of the CO Plus

In the following example, the revenue sharing mechanism for the CO Plus product is illustrated in detail. Naturally, in this example the initiated positions for CO Pluses are also butterflies. In order to show how to system works in its totality, basically the same numbers are used as in the prior buying example. Additional assumptions are made regarding the outcome of the investment process. For this, the only extra input that is needed for the system here is the expiration value of the underlying value.

In FIG. 6, an overview of the process for revenue sharing is outlined. The process starts with the determination of the market outcome, i.e. the expiration price of the ANNY-Index. In order to share the revenue, first the total revenue of the total Cooperative position is determined. This amount is the revenue on expiration of all the butterfly positions. For there to be a positive amount, at least one of the butterflies should expire in-the-money. This is the case if, for at least one of the butterflies, the expiration value of the underlying value is between the low-end price and the high-end price. So in this example this would be the case if the expiration price of the ANNY would be between 365 and 395.

In this case, we assume that the expiration value for the underlying index, the ANNY, is 386. Given this value the expiration value for the position of the cooperation can be calculated. In this example Table 26, which is identical to Table 21, lists the expiration value for all the underlying options:

TABLE 26

| Option Series | Position | Call Value | Expiration Value |
|---|---|---|---|
| July 365 Call | 218 | [symbol] 2100 | [symbol] 457800 |
| July 370 Call | −270 | [symbol] 1600 | [symbol] −432000 |
| July 375 Call | 25 | [symbol] 1100 | [symbol] 27500 |
| July 380 Call | 32 | [symbol] 600 | [symbol] 19200 |
| July 385 Call | 69 | [symbol] 100 | [symbol] 6900 |
| July 390 Call | −292 | 0 | 0 |
| July 395 Call | 218 | 0 | 0 |
| Total | | | [symbol] 79400 |

The expiration value amounts in the right column sum up to ε79400, which is the amount available for distribution.

Following the determination of the total amount available for distribution to the participants, this is subdivided between the CO Single options and the CO Plus options. Prior to the start of the process, from the internal accounting system follows the positions of the CO Plus. This is the basis for the distribution to CO Plus buyers. In Table 28, which is the same as Table 23 above, shows the positions held by the CO Plus holders.

TABLE 28
Total Butterfly Position per Product and per Range

| | Total Butterfly Position | CO Single | CO Plus |
|---|---|---|---|
| | Price Range | Positions | Position |
| Low2 | 365-370-375 | 72.6667 | 145.3333 |
| Low1 | 370-375-380 | 55.3333 | 110.6667 |
| Mid | 375-380-385 | 46.3333 | 92.6667 |
| High1 | 380-385-390 | 48 | 96 |
| High2 | 385-390-395 | 72.6667 | 145.3333 |

Given the position in individual butterflies, the revenue can be found for every range of the CO Plus. This is done in the following table, which also shows the total revenue that is available for holders of CO Plus options.

TABLE 29

| | | | | Expiration |
|---|---|---|---|---|
| | Average | Position | Expiration | Value CO |
| Price | Price per | Total CO | Value | Plus |
| Range | Butterfly | Singles | CO Plus | Position |
| Low2 | [symbol] 68.8073 | 145.3333 | 0 | 0 |
| Low1 | [symbol] 90.3614 | 110.6667 | 0 | 0 |
| Mid | [symbol] 107.9137 | 92.66667 | 0 | 0 |
| High1 | [symbol] 104.1667 | 96 | [symbol] 400 | [symbol] 38400 |
| High2 | [symbol] 68.8073 | 145.3333 | [symbol] 100 | [symbol] 14,533.33 |

| | |
|---|---|
| Total Revenue CO Plus | [symbol] 52,933.33 |

Upon the calculation of the amount, the order of the ranges for the CO Plus is determined. This is done in a straightforward and non-ambiguous manner. Although there are numerous ways to implement the distribution of the revenues for the CO Pluses within the system, we choose this example.

The first place is reserved for the CO Plus range in which the expiration value for the underlying value is. Since the expiration value of the underlying value, the ANNY index, 386, is in the High1 range, 382.50-387.50 this range is the HIT range. The second place is for the High2 range, 387.50-392.50 since the low end of the High2 range (387.50) is closer to 386 than the high end of the Mid range (377.50-382.50). The third place is for the Mid range, 377.50-382.50 since the high end of the Mid range (382.50) is closer to 386 than the high end of the Low1 range (377.50). The fourth place is for the Low 1 range, 372.50-377.50 since the high end of the Low1 range (377.50) is closer to 384 than the high end of the Low2 range (372.50). The fifth place is, finally, for the Low2 range, 367.50-372.50. Any rules the operator must comply with for conducting every distribution, will need to include disclaimers and certain explicit rules for specific unlikely although theoretically possible, events. These are not described in this example.

After the determination of the ranking order of the ranges, the revenue sharing mechanism proceeds to the next step. This step is the first of the allocation steps of the mechanism. Allocation takes place according to the ranking order.

Each of the following steps takes place subject to the availability of funds to be distributed. If the funds are exhausted at any point, the distribution stops. Accordingly, in every step the availability of funds to be distributed is explicitly taken into account.

| | |
|---|---|
| Total amount to be distributed: | [symbol] 52,933.33 |

Firstly, the total amount to be allocated to the first place price range, the HIT range is determined. This is done according to the following formula:

The minimum of the following two amounts:
{[50% of the width of the range]×position total×contract size}, and
the total amount available for redistribution

The width of the price range is the difference between the low end and the high end of the CO Plus range. For example, here the width of all the ranges is ε5, so 50% of this is ε2.50. (For example the difference between 377.50−382.50 is 5 points.)

In this example, the amount is ε2.50*96*100=ε24,000. The position total is given by the option position of the CO Plus (96 whole contracts) multiplied by the contract size (100).

| | |
|---|---|
| Total amount to distribute: | [symbol] 52,933.33 |
| HIT-range participants | [symbol] −24,000.00 |
| Remainder to be distributed | [symbol] 28,933.33 |

Secondly, in case there is an amount left, the amount to be allocated to the second place price range (High2) is determined. This is done according to the following formula: The minimum of the following two amounts:
[130% of the net invested amount], and
the total amount available for redistribution

Since the net invested amount is 9976 Euro (ε68.8073 price per CO Plus×145.3333 CO Plus positions), 130% of this amount is 12,968.8 Euro. Since this is less than the amount still available for allocation, 28,933.33 Euro, this amount is allocated to the High2 Range investors. After the distribution to the second place price range, there are still funds remaining for distribution.

| | |
|---|---|
| Total amount to be distributed: | [symbol] 52,933.33 |
| HIT-range participants | [symbol] −24,000.00 |
| Second Place participants | [symbol] −12,968.80 |
| Remainder to be distributed | [symbol] 15,964.53 |

Thirdly, the amount to be allocated to the third place range, in this example the (Mid) is determined. This is done according to the following formula: The minimum of the following two amounts:
[110% of the net invested], and
the total amount available for redistribution

Since the net invested amount is 10,000 (ε107.9137 price per CO Plus×92.66667 CO Plus positions), 110% of this amount is 11,000 Euro. Since this is less than the amount still available for allocation (15,964.53 Euro), this amount is allocated to the Mid Range participants.

| | |
|---|---|
| Total amount to distribute: | [symbol] 52,933.33 |
| HIT-range participants | [symbol] −24,000.00 |
| Second Place participants | [symbol] −12,968.80 |
| Third Place participants | [symbol] −11,000.00 |
| Remainder to be distributed | [symbol] 4,964.53 |

Fourthly, the amount to be allocated to the fourth place range (Low1) is determined. This is done according to the following formula: The minimum of the following two amounts:
[100% of the net invested], and
the total amount available for redistribution

Since the net invested amount is 10,000 Euro, 100% of this amount is 10,000 Euro. Since this is higher than the amount still available for allocation (4964.53 Euro), only the amount that is left is allocated to the Low1 Range participants.

| | |
|---|---|
| Total amount to distribute: | [symbol] 52,933.33 |
| HIT-range participants | [symbol] −24,000.00 |
| Second Place participants | [symbol] −12,968.80 |
| Third Place participants | [symbol] −11,000.00 |
| Fourth Place participants | [symbol] −4,964.53 |
| Remainder to be distributed | [symbol] 0 |

The subsequent steps are included for completeness.

Fifthly, the amount to be allocated to the fifth place range (Low2) is determined. This is done according to the following formula: The minimum of the following two amounts:
[100% of the net invested amount after provisions of the corporation], and
the total amount available for redistribution

Since no more funds are available, no funds are allocated in this step.

After this final step when, as in other examples, any funds are still available, the following two steps are included. Firstly, a bonus amount is allocated to the HIT price range, up to the point that would mark the maximum possible revenue on the particular option strategy. For the plain vanilla CO Single, the maximum possible revenue is given by the width of the range. So in this step the allocation formula is given by

The minimum of the following two amounts:
{[50% of the width of the range]×position total}, and
the total amount available for redistribution
   which is of course the same as in the first allocation step. It is obvious that these two steps combined could give the winner range the maximum possible amount of 100% of the maximum possible revenue.

Secondly, if any amounts are still available after the maximum possible return to the HIT range is allocated, the rest is given to the second place range. Given the structure of the revenue of the option position, it is not possible that the amount allocated to the second place range would in this case exceed the maximum possible revenue in a butterfly position. Subsequently as no more funds are available, no funds are allocated in further steps and no further steps are included in this procedure.

There is one instance in which the rules for the third place are adjusted. This is when either the Low2 range or the High2 range are the winner. In that case, they also receive the compensation for the third place. The compensation for what would have been the third place (always the Mid range) is now the same as the compensation of the fourth place, being at maximum a return of the investment. The fourth and fifth place then takes place after the second compensation of the first place. These all are then maximized at 100% of the net invested amount. If after these steps funds are still available for allocation, the allocation proceeds with the extra steps as mentioned above, a bonus allocation for the HIT range and the second place range if sufficient funds are available. After completion the allocation steps, the allocated amounts in every range are attributed to the individual investors based on their individual positions.

In this example, the expiration costs owed to the exchange and brokers are paid by the operator. These costs must be paid from the percentages of the distributed amounts. The operator can charge a percentage of the distributed amounts.

Comparison between the CO Single and the CO Plus

TABLE 30

| | | | Return | | | |
|---|---|---|---|---|---|---|
| | | | from | | Return from | |
| | | Avg. Price | expiration | | expiration | |
| | | per | from the | | from the | |
| Range | ANNY Index | Butterfly | CO Plus | ROI (%) | CO Single | ROI (%) |
| Low2 | 365-370-375 | [symbol] 68.8073 | 0 | −100% | 0 | −100% |
| Low1 | 370-375-380 | [symbol] 90.3614 | [symbol] 44.86 | −50.35% | 0 | −100% |
| Mid | 375-380-385 | [symbol] 107.9137 | [symbol] 118.70 | 10% | 0 | −100% |
| High1 | 380-385-390 | [symbol] 104.1667 | [symbol] 250 | 140% | [symbol] 400 | 284% |
| High2 | 385-390-395 | [symbol] 68.8073 | [symbol] 89.23 | 30% | [symbol] 100 | 45.33% |

From the example used in this report the comparison shows that a CO Plus gives a lower return on the investment by offering a portion of the profit to be distributed to the others. Consequently, the participants in the Mid realize a profit even in the event of poor judgment. The participants in the Low1 Range, far from the HIT Range, still receive nearly 50% of their investment, whereas they would have suffered a complete loss of their investment if they would have invested in a CO Single.

The conclusion is that given the total investment of the cooperative, the insurance is based on a premium paid as a part of the future profit. It depends on the investor's own financial insights and preferences whether he or she prefers a CO Single or a CO Plus investment vehicle.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A system for the cooperative trading of options units by individual investors utilizing a cooperative option exchange based upon collective member unit purchases for profit sharing among investor member units of pre-selected structured financial products on a predetermined pro rata basis, comprising the steps of:
selecting one or more structured financial products and determining the option combination ranges and pricing for the cooperative investment by the cooperative investment operator;
listing the option combination ranges and pricing on an Internet accessible web portal for use by individual investors in purchasing one or more options units within the option combination ranges for selective investment by the investors;
purchasing one or more options units in one or more selected combination ranges by one or more individual investors having online financial accounts accessible to the operator of the web portal and tabulating said purchased options units;
calculating the one or more options units required to be purchased by the cooperative investment operator based upon the tabulated purchased options units by netting such purchases to reduce the absolute number of said purchases of options units to the minimum number of options units required to meet the aggregate invested amount;
calculating total cost of the netted number of options units, including options unit and brokerage and exchange fees, and purchasing said options units on the appropriate options trading exchange;
awaiting expiration of the purchased options units and calculating the resulting individual investor positions based upon their respective purchasing of options units and the options trading outcome on the appropriate exchange; and,
determining the total amount available for payout to the one or more individual investors and crediting their respective online financial accounts based upon a predetermined pro rata profit sharing based upon the specific investment by an individual investor of the one or more selected option combination ranges.

2. The system of claim 1 further including the steps of:
predetermining the allocation of revenue received by the cooperative investment operator for pro rata distribution to the individual investors based upon the specific investment by an individual investor in accordance with the purchase of the one or more selected option combination ranges, the greater share of profit being accorded to the one or more individual investors selecting for purchase the option combination range having the greater outcome return and a lesser share of profit being accorded to the one or more individual investors selecting for purchase the option combination range having the next greater outcome return and, if funds remain available for distribution, a lesser share of profit being accorded to the one or more individual investors selecting for purchase the option combination range having the next greater outcome return.
